(19) United States
(12) Patent Application Publication
(10) Pub. No.: US 2019/0347808 A1
(43) Pub. Date: Nov. 14, 2019

(54) Monocular Visual Odometry: Speed And Yaw Rate Of Vehicle From Rear-View Camera

(71) Applicant: Ford Global Technologies, LLC, Dearborn, MI (US)

(72) Inventors: Xue Iuan Wong, Dearborn, MI (US); Tewodros Atanaw Biresaw, Sunnyvale, CA (US); Kyle J. Carey, Ypsilanti, MI (US)

(21) Appl. No.: 15/975,319

(22) Filed: May 9, 2018

(51) Int. Cl. G06T 7/246

(52) U.S. Cl. CPC G06T 7/248; G06T 2207/10016; G06T 2207/30252

(57) ABSTRACT

According to one embodiment, a method for estimating a speed and yaw rate of a vehicle based on images received from a monocular camera is disclosed. The method includes receiving sequential images comprising a first image and a second image from a camera of a vehicle. The method includes extracting one or more ground features from each of the sequential images and computing coordinates for a ground feature of the first image and the second image. The method includes estimating speed and yaw rate of the vehicle based on a change in the coordinates for the ground feature from the first image to the second image.

### TECHNICAL FIELD

The disclosure relates generally to methods, systems, and devices for determining one or more of a speed and a yaw rate of a vehicle. The disclosure particularly relates to determining a speed and yaw rate of a vehicle based on sequential images received from a monocular camera of the vehicle.

### BACKGROUND

Automobiles provide a significant portion of transportation for commercial, government, and private entities. Autonomous vehicles and driving assistance systems are currently being developed and deployed to provide safety, reduce an amount of user input required, or even eliminate user involvement entirely. For example, some driving assistance systems, such as crash avoidance systems, may monitor driving, positions, and a velocity of the vehicle and other objects while a human is driving. When the system detects that a crash or impact is imminent the crash avoidance system may intervene and apply a brake, steer the vehicle, or perform other avoidance or safety maneuvers. As another example, autonomous vehicles may drive and navigate a vehicle with little or no user input. Accurate and fast determination of the vehicle's speed and yaw rate is often necessary to enable automated driving systems or driving assistance systems to safely navigate roads or driving routes.

### BRIEF DESCRIPTION OF THE DRAWINGS

Non-limiting and non-exhaustive implementations of the present disclosure are described with reference to the following figures, wherein like reference numerals refer to like parts throughout the various views unless otherwise specified. Advantages of the present disclosure will become better understood with regard to the following description and accompanying drawings where:

FIG. 1 is a schematic block diagram illustrating an implementation of a vehicle control system that includes an automated driving/assistance system, according to one implementation;

FIG. 2 illustrates a schematic block diagram of an example process flow for estimating a speed and yaw rate of a vehicle based on images from a camera, according to one implementation;

FIG. 3 illustrates an example image captured by a monocular camera of a vehicle, according to one implementation;

FIG. 4 illustrates an example sequence of images captured by a monocular camera of a moving vehicle, according to one implementation;

FIG. 5 illustrates a schematic flow chart diagram of a method for estimating a speed and yaw rate of a vehicle, according to one implementation;

FIG. 6 illustrates a schematic flow chart diagram of a method for estimating a speed and yaw rate of a vehicle, according to one implementation; and

FIG. 7 is a schematic block diagram illustrating an example computing system, according to one implementation.

### DETAILED DESCRIPTION

Determination of a vehicle's speed and yaw rate in real-time can be an important aspect of improving operation of autonomous vehicles or driver assistance features. For example, a vehicle must know precisely its current velocity and yaw rate to navigate safely. A variety of current approaches exist to determine a vehicle's speed and yaw rate, but such approaches require substantial computation or necessitate the use of expensive sensors.

The location, motion, and orientation parameters of a vehicle must be measured accurately to enable autonomous features for the vehicle such as driver assistance features. Various sensors, including global positioning sensors, inertial measurement unit sensors, and wheel encoders can be used for measuring such parameters. However, such sensors are not effective across a range of speeds and may provide inaccurate results in varying conditions. For example, wheel encoders are affected by slippage of the vehicle due to road conditions and the accuracy of data received from wheel encoders is poor at slow speeds such as in parking scenarios. Inertial measurement unit sensors are noisy and prone to drifting. Further, global positioning systems are dependent on the environment and the accuracy of such systems is associated with high cost.

Applicant recognizes that cameras with appropriate computer vision may be utilized to overcome the limitations of the aforementioned sensors, including global positioning systems, inertial measurement unit sensors, and wheel encoders. Applicant recognizes that stereo-camera based visual odometry is computationally expensive and requires dedicated camera pairs on the vehicle. As modern vehicles are equipped with rear-view cameras, monocular visual odometry may be developed without the need of extra sensor cost.

Traditional monocular visual odometry relies on Epipolar Geometry Theorem to compute the relative poses between two camera images. However, the underlying principle of the Epipolar Geometry Theorem requires a sufficient amount of motion between captured images, or the solution will be trapped in a null motion ambiguity. On the other hand, the monocular visual odometry that utilizes additional information can only compute the translation up to a scale factor, namely only in the direction of travel to be computed. Such constraints have previously prohibited the use of implementations of monocular visual odometry for vehicle motion estimation.

Before the methods, systems, and devices for estimating a vehicle's speed and yaw rate based on monocular visual odometry are disclosed and described, it is to be understood that this disclosure is not limited to the configurations, process steps, and materials disclosed herein as such configurations, process steps, and materials may vary somewhat. It is also to be understood that the terminology employed herein is used for describing implementations only and is not intended to be limiting since the scope of the disclosure will be limited only by the appended claims and equivalents thereof.

In describing and claiming the disclosure, the following terminology will be used in accordance with the definitions set out below.

It must be noted that, as used in this specification and the appended claims, the singular forms “a,” “an,” and “the” include plural referents unless the context clearly dictates otherwise.

As used herein, the terms “comprising,” “including,” “containing,” “characterized by,” and grammatical equivalents thereof are inclusive or open-ended terms that do not exclude additional, unrecited elements or method steps.

Applicant has developed systems, methods, and devices for determining a vehicle's current speed and yaw rate in real-time based on input received from a monocular camera of the vehicle. According to one embodiment, a method for determining a speed and yaw rate of a vehicle is disclosed. The method includes receiving sequential images comprising a first image and a second image from a camera of a vehicle. The method includes extracting one or more ground features from each of the sequential images. The method includes computing coordinates for a ground feature of the first image and the second image and estimating speed and yaw rate of the vehicle based on a change in the coordinates for the ground feature from the first image to the second image.

Various embodiments of the disclosure are configured to detect key-point features in sequential images for recovering kinematic parameters of a vehicle. Such systems, methods, and devices as disclosed utilize a monocular camera and resolve prior issues associated with monocular cameras including the scale ambiguity issue. Embodiments of the disclosure are particularly suited to slower vehicle speeds where other methods based on Epipolar Geometry Theorem or Homography Transform have failed. Applicant further presents systems, methods, and devices that are capable of outputting real-time measurement covariance that measures the reliability of an estimation output.

Further embodiments and examples will be discussed in relation to the figures below.

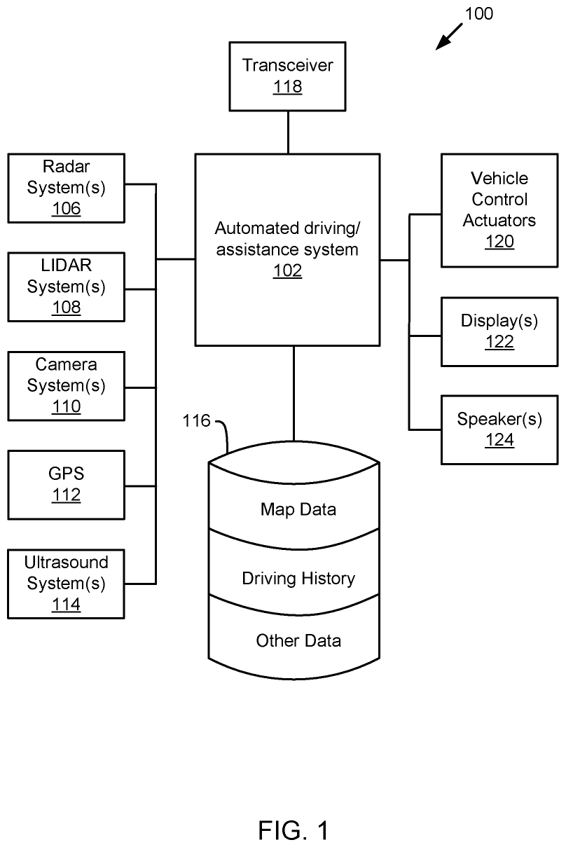

Referring now to the figures, FIG. 1 illustrates an example vehicle control system 100 that may be used to automatically localize a vehicle. The automated driving/assistance system 102 may be used to automate or control operation of a vehicle or to provide assistance to a human driver. For example, the automated driving/assistance system 102 may control one or more of braking, steering, acceleration, lights, alerts, driver notifications, radio, or any other auxiliary systems of the vehicle. In another example, the automated driving/assistance system 102 may not be able to provide any control of the driving (e.g., steering, acceleration, or braking), but may provide notifications and alerts to assist a human driver in driving safely. The automated driving/assistance system 102 may use a neural network, or other model or algorithm to detect or localize objects based on perception data gathered by one or more sensors.

The vehicle control system 100 also includes one or more sensor systems/devices for detecting a presence of objects near or within a sensor range of a parent vehicle (e.g., a vehicle that includes the vehicle control system 100). For example, the vehicle control system 100 may include one or more radar systems 106, one or more LIDAR systems 108, one or more camera systems 110, a global positioning system (GPS) 112, and/or one or more ultrasound systems 114. The vehicle control system 100 may include a data store 116 for storing relevant or useful data for navigation and safety such as map data, driving history or other data. The vehicle control system 100 may also include a transceiver 118 for wireless communication with a mobile or wireless network, other vehicles, infrastructure, or any other communication system.

The vehicle control system 100 may include vehicle control actuators 120 to control various aspects of the driving of the vehicle such as electric motors, switches or other actuators, to control braking, acceleration, steering or the like. The vehicle control system 100 may also include one or more displays 122, speakers 124, or other devices so that notifications to a human driver or passenger may be provided. A display 122 may include a heads-up display, dashboard display or indicator, a display screen, or any other visual indicator which may be seen by a driver or passenger of a vehicle. The speakers 124 may include one or more speakers of a sound system of a vehicle or may include a speaker dedicated to driver notification.

It will be appreciated that the embodiment of FIG. 1 is given by way of example only. Other embodiments may include fewer or additional components without departing from the scope of the disclosure. Additionally, illustrated components may be combined or included within other components without limitation.

In one embodiment, the automated driving/assistance system 102 is configured to control driving or navigation of a parent vehicle. For example, the automated driving/assistance system 102 may control the vehicle control actuators 120 to drive a path on a road, parking lot, driveway or other location. For example, the automated driving/assistance system 102 may determine a path based on information or perception data provided by any of the components 106-118. The sensor systems/devices 106-110 and 114 may be used to obtain real-time sensor data so that the automated driving/assistance system 102 can assist a driver or drive a vehicle in real-time.

In one embodiment, the vehicle control system 100 includes a localization component 104 to determine a location of the vehicle with respect to map, roadway, or the like. For example, the localization component 104 may use an on-board camera to localize the vehicle with respect to a prior created or obtained map. In one embodiment, the localization component 104 may enable the vehicle control system 100 to localize the vehicle without using active sensors such as LIDAR or radar, which emit energy in the environment and detect reflections. The map may include a vector-based semantic map or a LIDAR intensity map. A projected top-down image derived from the camera is created and compared to either a previously made vector or a LIDAR intensity map. The comparing process can be done by using technique like mutual information or by comparison techniques that provide a best-fit relative position.

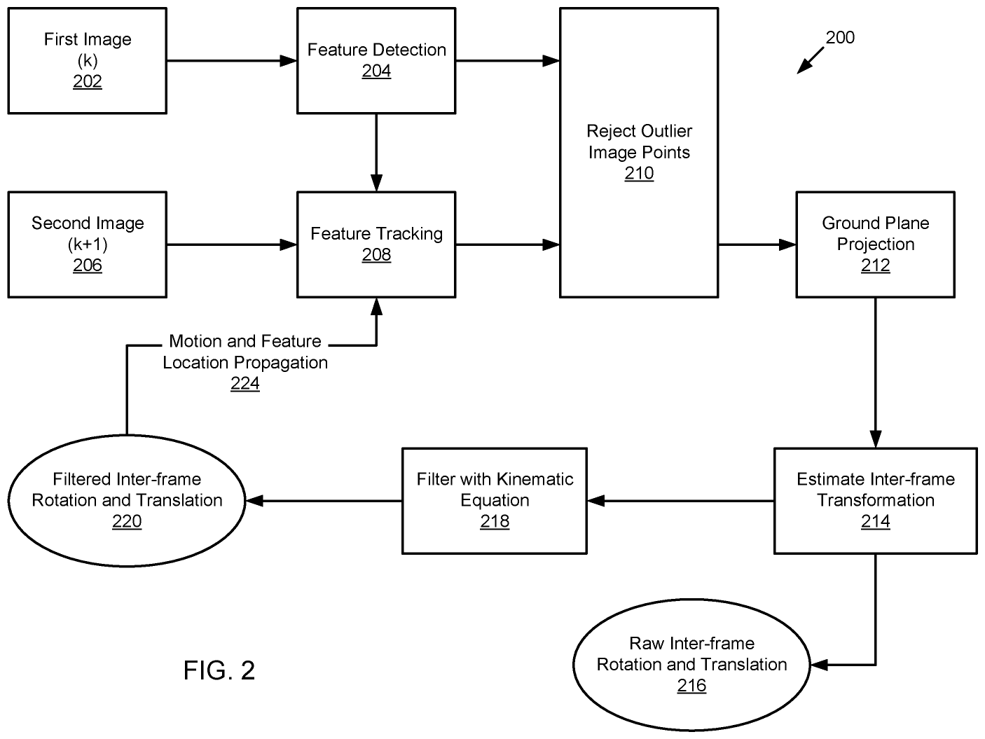

FIG. 2 illustrates an example process flow 200 of a method for estimating a speed and yaw rate of a vehicle. The process flow 200 includes receiving a first image 202 (represented as time k) and a second image 206 (represented as time k+1). The second image 206 is captured by a monocular camera subsequent to capturing the first image 202. In an embodiment, the first image 202 and the second image 206 are sequential images captured in a quick time succession. The process flow 200 includes feature detection 204 of the first image 202 and feature tracking 208 of the second image 206. The process flow 200 includes rejecting outlier image points at 210. After outlier image points have been rejected, a ground plane projection 212 is generated. Based on the ground plane projection 212, the process flow 200 includes estimating inter-frame transformation at 214 to generate raw inter-frame rotation and translation 216. The process flow 200 includes filtering with the kinematic equation at 218 to generate filtered inter-frame rotation and translation 220. The filtered inter-frame rotation and translation 220 undergoes motion and feature location propagation at 224 and feature tracking at 208.

The process flow 200 framework detects key-point features in sequential images for recovering kinematic parameters of a vehicle. Given an input including sequential images, such as first image 202 and second image 206, a region of interest (ROI) of each image of the sequential images is extracted. In an embodiment, a majority of the region of interest is filled with a ground plane surrounding a rear or a vehicle. The ground plan assists in overcoming the scale problem traditionally experienced in monocular visual odometry. The region of interest indicates a sub-image of the original image and the region of interest may be processed with an adaptive histogram equalization algorithm to enhance the visibility of image features within the region of interest.

The feature detection 204 includes extracting a region of interest (ROI) from the first image 202 and one or more additional images received from a monocular camera. In an embodiment, the feature detection 204 extracts a region of interest from an area surrounding a vehicle and may particularly include extracting a ground plane region surrounding a rear of a vehicle. In an embodiment, a majority of the region of interest is filled with ground plane and includes ground features. Ground features include, for example, image points detected on a ground plane surrounding the monocular camera. In an embodiment, the ground features include image points pertaining to, for example, an asphalt, concrete, or dirt surface surrounding a vehicle and may particularly pertain to detectable and trackable objects located on or within the ground plane.

The feature detection 204 includes computing three-dimensional coordinates for the ground features in the region of interest. In an embodiment, the three-dimensional coordinates are computed using an optical flow algorithm for computing correspondence between ground features in two sequential images. A set of three-dimensional coordinates of one or more ground features is computed in real-time for each of the sequential images. Correspondence between ground features from two sequential images are computed using the optical flow algorithm. For a given camera configuration and image coordinate of a set of ground features, the three-dimensional coordinates indicate the intersection of a camera ray and the ground plane.

The optical flow algorithm estimates motion based on sequential images as either instantaneous image velocities or discrete image displacements. In an embodiment, the optical flow algorithm calculates the motion between two sequential images taken at time k and time k+1 at every voxel position. In such an embodiment, the measurement is based on local Taylor series approximations of the image sequence using partial derivatives with respect to spatial and temporal coordinates of the images. It should be appreciated that any suitable method or any suitable optical flow algorithm may be used without departing from the scope of the disclosure. Example optical flow algorithm methods include, for example, the Lucas-Kanade method, the Horn-Schunuck method, the Buxton-Buxton method, the Black-Jepson methods, general variational methods, discrete optimization methods, phase correlation methods, and block-based methods.

The feature tracking 208 includes extracting a corresponding region of interest from the second image 206 that corresponds at least in part to the region of interest extracted from the first image 202 by the same process disclosed for feature detection 204. In an embodiment, the monocular camera, and/or the vehicle upon which the monocular camera is attached, has moved between the first image 202 and the second image 206. In such an embodiment, a portion of the region of the interest of the second image 206 will correspond to, or be equivalent to, a portion of the region of interest of the first image 202. It should be appreciated that at least one point or ground feature should correspond between the region of interest of the first image 202 and the region of interest of the second image 206. In an embodiment as illustrated with respect to the feature detection 204 process, a majority of the region of interest is filled with ground plane including ground features. The feature tracking 208 utilizes an optical flow algorithm to compute correspondence between the ground features detected in the first image 202 and the corresponding ground features detected in the second image 206, wherein the first image 202 and the second image 206 are sequential images taken by a monocular camera. The feature tracking 208 further computes a set of three-dimensional coordinates for the ground features of the second image 206.

The process of rejecting outlier image points at 210 reduces error in the optical flow estimation through use of median flow outlier rejection. The process of rejecting outlier image points at 210 includes estimating a median flow indicating a general flow or movement of the image, wherein the median flow is calculated as the median of the movement of all image points between two or more sequential images. In an embodiment, the median flow indicates a general flow or movement of the monocular camera between a first image 202 and a second image 206. The process of rejecting outlier images points at 210 includes eliminating all image points of the first image 202 and the second image 206 that have a large deviation from the median flow. In an embodiment, where the deviation from the median flow exceeds a predetermined threshold amount, the image point is rejected as an outlier. In an embodiment, an image point of the first image 202 and a corresponding image point of the second image 206 are each rejected as outliers where the change in coordinates from the image point of the first image 202 to the corresponding image point of the second image 206 is substantially greater than or less than the median flow.

The process of median flow outlier rejection reduces the correspondence error in the optical flow estimation that is computed by the optical flow algorithm at feature tracking 208. The median flow outlier rejection is based on the fact that detected and associated points in motion in an image plane (as the camera moves between sequential images) share a general direction as all the points are distributed on a flat ground plane. The median flow indicates a general motion of the image points and is computed as the median of the movement of all image points of a first image 202 and all corresponding image points of a second image 206 compared with the optical flow direction of each of the associated image points. The process of median flow outlier rejection eliminates points with large deviation from the median flow. In an embodiment where the vehicle is rotating, the median flow could be distributed by a wide region. Taking into account this effect, the region of interest on the ground plane is segmented into sub-images across a horizontal direction. Thus, image points in each of the sub-images are filtered by an independent median flow outlier rejection process.

The ground plane projection 212 extracts estimated ground points from each of the sequential images. For example, the ground plane projection 212 extracts an estimated ground point pₖ from the first image 202 and a corresponding estimated ground point pₖ₊₁ from the second image 206. For example, assuming there are a set of points in an image that are distributed on the ground i.e. “ground features,” a three-dimensional location p for each point is computed by projecting the image point onto the ground plane.

The process of estimating inter-frame transformation at 214 includes receiving the estimated ground points from the ground plane projection 212 and, based on the estimated ground points, determining a motion and orientation change of the camera between the first image 202 and the second image 206 using rigid body transformation. In an embodiment, the rotation and translation are minimized by a least square cost function developed based on the rigid body transformation equation. The process of rigid body transformation preserves a distance between points in a rigid body, and as such, the motion and orientation change of the monocular camera, or a vehicle that the monocular camera is adhered to, may be measured. Given a first set of points from the first image 202 and a second set of points from the second image 206, inter-frame rotation and translation is concluded with rigid body transformation according to Equation 1, below.

pₖ₊₁=Rpₖ+t Equation 1

In Equation 1, the variable pₖ₊₁ refers to an image point extracted from the second image 206. The variable R refers to the rotation between the first image 202 and the second image 206. The variable pₖ refers to an image point corresponding to pₖ₊₁ that is extracted from the first image 202. The variable t refers to the translation.

During practical application of the process of estimating inter-frame transformation at 214, the raw sensor output is generally noisy or has failed to converge due to the existence of outlier image noise and external noise factors. When a secondary measurement is available, the process at 214 utilizes a sensor fusion framework to improve measurement accuracy. In an embodiment where a camera-only measurement is desired or required, the process at 214 utilizes an algorithm having an alpha-beta filter that uses past history of the estimation result and the kinematic model of the vehicle to filter the raw visual odometry measurements.

The raw inter-frame rotation and translation 216 is an output from the process of estimated inter-frame transformation at 214. In an embodiment, the rotation measured from the first image 202 to the second image 206 is represented as Rₖ₊₁. In an embodiment, the translation measured from the first image 202 to the second image 206 is represented as tₗ₊₁. In an embodiment, rotation and translation is estimated according to Equation 2, below.

min RT J=[pₖ₊₁−\hat{R}pₖ−\hat{t}]^{T}[pₖ₊₁−\hat{R}pₖ−\hat{t}] Equation 2

In Equation 2, the variable pₖ₊₁ refers to an image point extracted from the second image 206. The variable \hat{R} refers to the filtered inter-frame rotation after it has been filtered with the kinematic equation. The variable pₖ refers to an image point corresponding to pₖ₊₁ that is extracted from the first image 202. The variable \hat{t} refers to the filtered inter-frame translation after it has been filtered with the kinematic equation.

The process of filtering with kinematic equation at 218 includes determining a speed and yaw-rate of the vehicle based on an output received from the process of estimating inter-frame transformation at 214. For example, the rotation Rₖ₊₁ and translation tₖ₊₁ are utilized to determine the speed and yaw-rate of the vehicle. In an embodiment, the process of filtering with kinematic equation at 218 includes utilizing an algorithm having an alpha-beta filter that uses past history of the estimation results and the kinematic model of the vehicle to filter the raw visual odometry measurements.

The filtered inter-frame rotation and translation 220 is received as an output from the process of filtering with kinematic equation at 218. In an embodiment, a filtered rotation measurement and a filtered translation measurement are received. It should be appreciated that these outputs may be utilized for determining a speed and yaw-rate of the vehicle based on sequential images, including the first image 202 and the second image 206.

In an embodiment, rotation of the monocular camera (or the vehicle upon which the monocular camera is attached) is parameterized with Classical Rodriguez Parameter (CRP) with Cayley Transform, as indicated by Equations 3-5, below.

$$\begin{matrix}R = {[ I + Q ( q ) ]}^{- 1} [ I - Q ( q ) ] & Equation 3 \\ q = [ {q}_{1} , {q}_{2} , {q}_{3} ] & Equation 4 \\ Q ( q ) = [ \begin{matrix}0 & - {q}_{3} & {q}_{2} \\ {q}_{3} & 0 & - {q}_{1} \\ - {q}_{2} & {q}_{1} & 0\end{matrix} ] & Equation 5\end{matrix}$$

CRP experiences singularity when rotation about the principle axis is greater than 71 However, this can be avoided when computing the inter-frame rotation from a monocular camera such as a vehicle-mounted monocular camera. Thus, assuming planar motion, the principle rotation angle is equal to the yaw angle. The CRP in terms of principle rotation angle is illustrated by Equation 6, below. The yaw angle is calculated according to Equation 7, below.

$$\begin{matrix}q = [ {q}_{x} , {q}_{y} , {q}_{z} ] tan \frac{∅}{2} & Equation 6 \\ Ψ \approx θ = 2 {tan}^{- 1} ( \vert q \vert ) & Equation 7\end{matrix}$$

The process of motion and feature location propagation at 224 receives the filtered rotation and translation measurements from the filtered inter-frame rotation and translation 220 that is processed by filtering with the kinematic equation at 218. The process of motion and feature location propagation at 224 improves the output of the process flow 200 using data from pervious estimations stored in memory by predicting feature point location before the optical flow algorithm is solved, identifying outlier points using a structure from motion algorithm, and supplying the feature points to the optical flow algorithm. In an embodiment, a filter is applied to the optical flow algorithm. The filter includes estimating a high order kinematic term from a previous measurement and propagating a state from the previous measurement and the estimated high order kinematic term. The real-time measurement calculated based on images received from the monocular camera is then fused with the propagation in a covariance weighted average or a simple average. This fusion provides an extra source of information based on previous measurements that can reduce error in determining one or more of the current speed and/or yaw rate of the vehicle.

In an embodiment, to further improve performance of the visual odometry framework of the process flow 200, the process of motion and feature location propagation at 224 includes a feedback loop mechanism that utilizes previous estimation results to improve computational cost, robustness, and accuracy of the estimation of motion and orientation change in sequential image frames. Assuming that the rate of change of the kinematic states are constraints to a small value when the targeting platform of the optical flow algorithm is a road vehicle system and the update frequency of the visual odometry algorithm is reasonably high, the vehicle motion at a current time step will be close to the vehicle motion at a previous estimation. The estimation of three-dimensional point locations with respect to the camera frame may also be stored in memory, the process at 224 may include predicting feature point location into the current measurement of sequential image frames before the optical flow algorithm is solved. The predicted feature point locations are projected into the sequential images including the first image 202 and the second image 206, to compute the prediction of an image point's location. The predicted image point's location is supplied to the optical flow algorithm as the initial condition. As the initial condition approaches the actual solution, the convergence properties of the optical flow estimation are improved.

Additionally, the feedback mechanism disclosed at process step 224 permits system to utilize a structure from motion algorithm to compute the three-dimensional coordinates of detected ground features and identify further outlier points. The structure from motion algorithm does not depend on the assumption that the ground features are distributed on the ground. The structure from motion algorithm may thus check to determine if a detected ground feature is indeed on the ground plane. Considering error caused by noisy measurement and/or camera calibration, the ground feature coordinates are subjected to test against a threshold value. When the differences between the estimated structure from motion ground feature's coordinates and the camera height is within the range of a threshold value, the ground feature is accepted as a ground feature located in the ground plane or it is otherwise rejected as an outlier.

Additionally, an instantaneous speed of the monocular camera (or the vehicle upon which the monocular camera is attached) may be calculated. Given a video frame rate “fps”, the instantaneous speed “v” is calculated according to Equation 8, below.

v=|t|×fps Equation 8

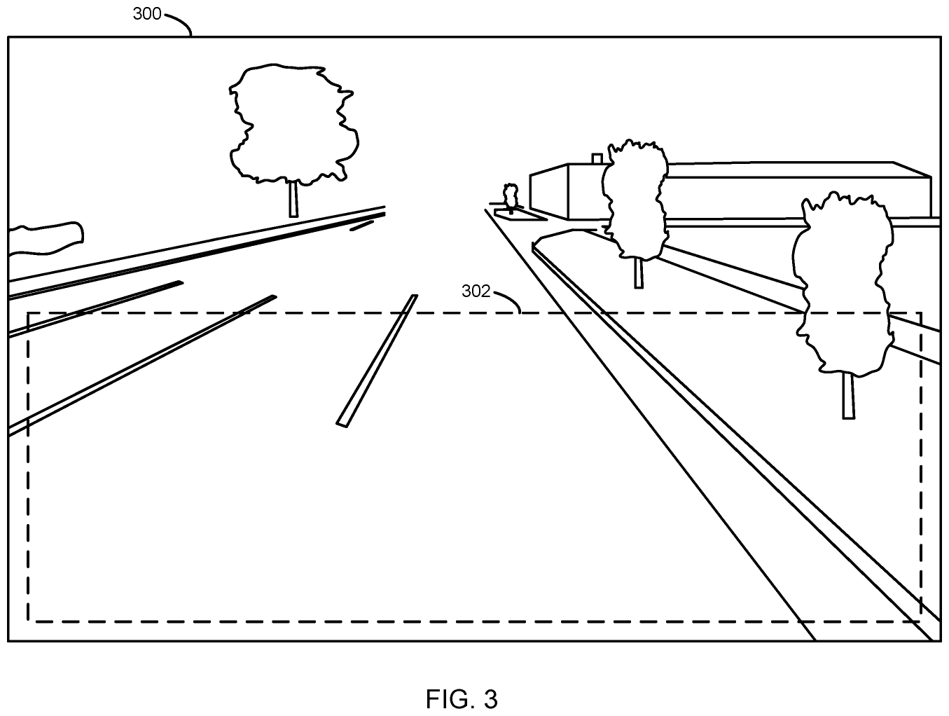

FIG. 3 illustrates an example image 300 captured by a monocular camera attached to a rear of a vehicle. A region of interest 302 is extracted from the image 300, and as shown in FIG. 3, a majority of the region of interest 302 comprises the ground plane surrounding the rear of the vehicle. The ground plane comprises one or more ground features, such as image points detectable in the ground plane, and the ground features may be utilized to estimate a speed and yaw-rate of the vehicle based on two or more sequential images captured by the camera.

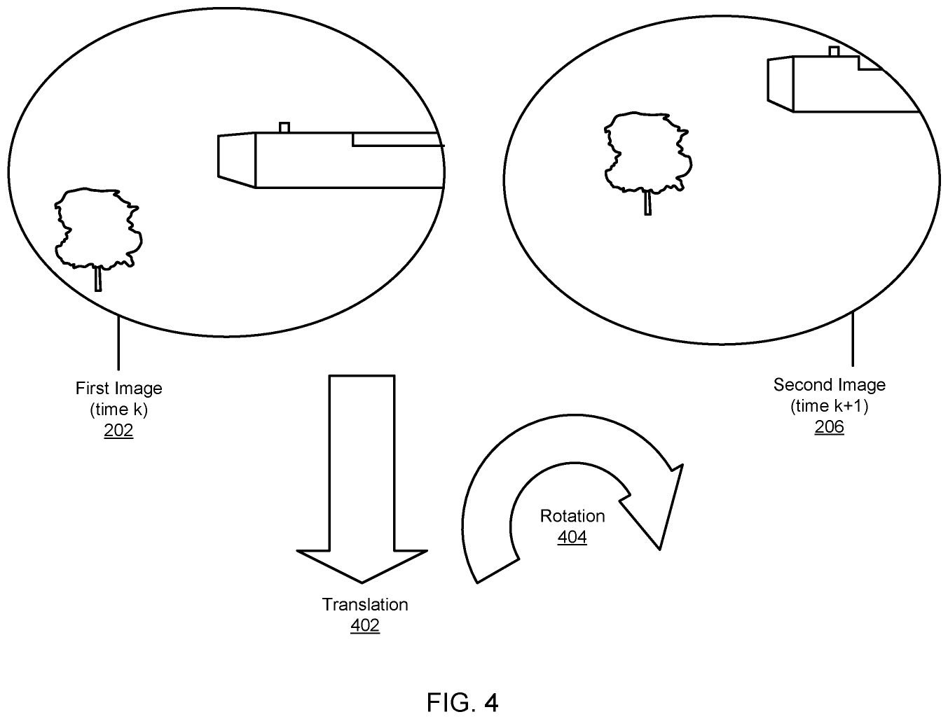

FIG. 4 illustrates a plurality of example images received from a monocular camera that may be utilized to calculate a translation and/or rotation of the monocular camera. The first image 202 is received from the camera at a time k and the second image 206 is received from the camera at a time k+1. As illustrated in FIG. 4, the camera has moved from time=k to time=k+1 and the scenery depicted in the first image 202 is different from the scenery depicted in the second image 206. In an embodiment, the translation 402 of the camera and the rotation 404 of the camera is calculated according to the process flow 200 illustrated in FIG. 2.

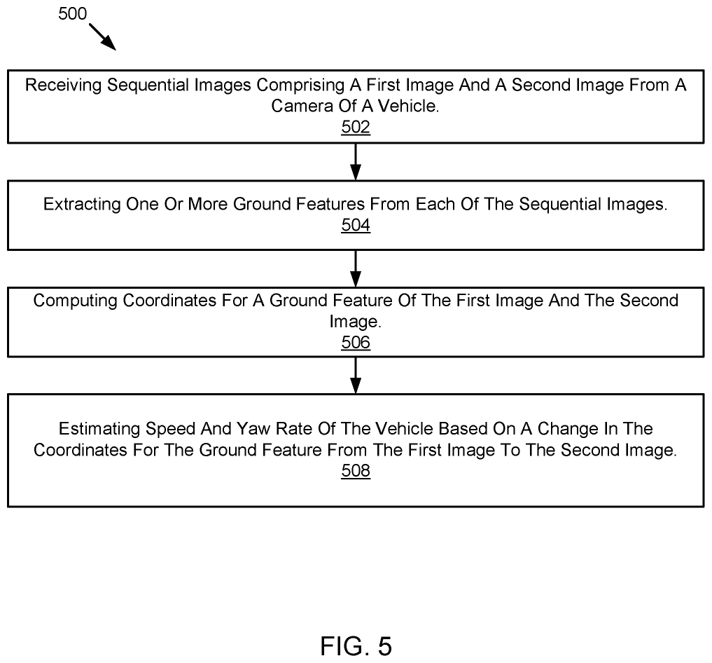

FIG. 5 illustrates a process flow chart diagram of a method 500 for estimating a speed and/or yaw rate of a vehicle. The method 500 begins and a processor, such as an automated driving/assistance system 102, receives sequential images comprising a first image 202 and a second image 206 from a camera of a vehicle at 502. The processor extracts one or more ground features from each of the sequential images at 504. The processor computes coordinates for a ground feature of the first image and the second image at 506. The processor estimates speed and yaw rate of the vehicle based on a change in the coordinates for the ground feature from the first image to the second image at 508.

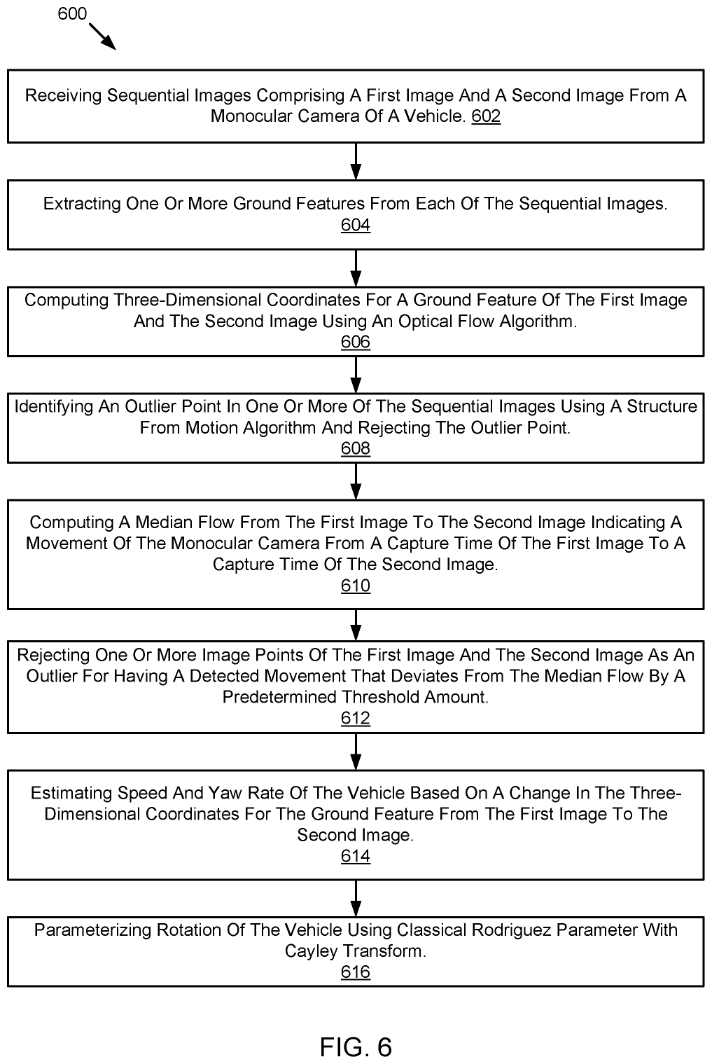

FIG. 6 illustrates a process flow chart diagram of a method 600 for estimating a speed and/or yaw rate of a vehicle. The method 600 begins and a processor, such as an automated driving/assistance system 102, receives sequential images comprising a first image 202 and a second image 206 from a monocular camera of a vehicle at 602. The processor extracts one or more ground features from each of the sequential images at 604. The processor computes three-dimensional coordinates for a ground feature of the first image and the second image using an optical flow algorithm at 606. The processor identifies an outlier point in one or more of the sequential images using a structure from motion algorithm and rejects the outlier point at 608. The processor computes a median flow from the first image to the second image indicating a movement of the monocular camera from a capture time of the first image to a capture time of the second image at 610. The processor rejects one or more image points of the first image and the second image as an outlier for having a detected movement that deviates from the median flow by a predetermined threshold amount at 612. The processor estimates speed and yaw rate of the vehicle based on a change in the three-dimensional coordinates for the ground feature from the first image to the second image at 614. The processor parametrizes rotation of the vehicle using Classical Rodriguez Parameter with Cayley Transform at 616.

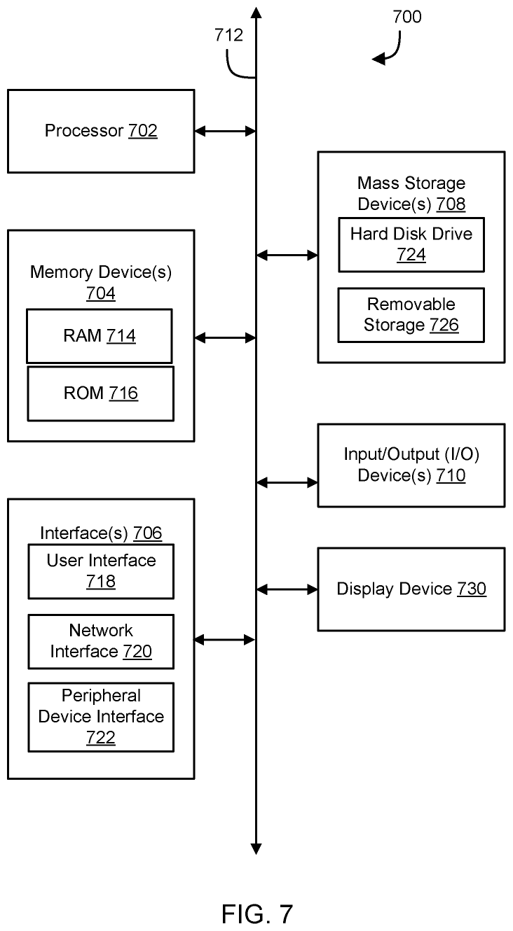

Referring now to FIG. 7, a block diagram of an example computing device 700 is illustrated. Computing device 700 may be used to perform various procedures, such as those discussed herein. In one embodiment, the computing device 700 can function as an automated driving/assistance system 102, vehicle control system, or the like. Computing device 700 can perform various monitoring functions as discussed herein, and can execute one or more application programs, such as the application programs or functionality described herein. Computing device 700 can be any of a wide variety of computing devices, such as a desktop computer, in-dash computer, vehicle control system, a notebook computer, a server computer, a handheld computer, tablet computer and the like.

Computing device 700 includes one or more processor(s) 702, one or more memory device(s) 704, one or more interface(s) 706, one or more mass storage device(s) 708, one or more Input/Output (I/O) device(s) 710, and a display device 730 all of which are coupled to a bus 712. Processor(s) 702 include one or more processors or controllers that execute instructions stored in memory device(s) 704 and/or mass storage device(s) 708. Processor(s) 702 may also include various types of computer-readable media, such as cache memory.

Memory device(s) 704 include various computer-readable media, such as volatile memory (e.g., random access memory (RAM) 714) and/or nonvolatile memory (e.g., read-only memory (ROM) 716). Memory device(s) 704 may also include rewritable ROM, such as Flash memory.

Mass storage device(s) 708 include various computer readable media, such as magnetic tapes, magnetic disks, optical disks, solid-state memory (e.g., Flash memory), and so forth. As shown in FIG. 7, a particular mass storage device is a hard disk drive 724. Various drives may also be included in mass storage device(s) 708 to enable reading from and/or writing to the various computer readable media. Mass storage device(s) 708 include removable media 726 and/or non-removable media.

I/O device(s) 710 include various devices that allow data and/or other information to be input to or retrieved from computing device 700. Example I/O device(s) 710 include cursor control devices, keyboards, keypads, microphones, monitors or other display devices, speakers, printers, network interface cards, modems, and the like.

Display device 730 includes any type of device capable of displaying information to one or more users of computing device 700. Examples of display device 730 include a monitor, display terminal, video projection device, and the like.

Interface(s) 706 include various interfaces that allow computing device 700 to interact with other systems, devices, or computing environments. Example interface(s) 706 may include any number of different network interfaces 720, such as interfaces to local area networks (LANs), wide area networks (WANs), wireless networks, and the Internet. Other interface(s) include user interface 718 and peripheral device interface 722. The interface(s) 706 may also include one or more user interface elements 718. The interface(s) 706 may also include one or more peripheral interfaces such as interfaces for printers, pointing devices (mice, track pad, or any suitable user interface now known to those of ordinary skill in the field, or later discovered), keyboards, and the like.

Bus 712 allows processor(s) 702, memory device(s) 704, interface(s) 706, mass storage device(s) 708, and I/O device(s) 710 to communicate with one another, as well as other devices or components coupled to bus 712. Bus 712 represents one or more of several types of bus structures, such as a system bus, PCI bus, IEEE bus, USB bus, and so forth.

For purposes of illustration, programs and other executable program components are shown herein as discrete blocks, although it is understood that such programs and components may reside at various times in different storage components of computing device 700 and are executed by processor(s) 702. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

### EXAMPLES

The following examples pertain to further embodiments.

Example 1 is a method for estimating one or more of a speed and a yaw rate of a vehicle. The method includes: receiving sequential images comprising a first image and a second image from a camera of a vehicle; extracting one or more ground features from each of the sequential images; computing coordinates for a ground feature of the first image and the second image; and estimating speed and yaw rate of the vehicle based on a change in the coordinates for the ground feature from the first image to the second image.

Example 2 is a method as in Example 1, wherein the ground feature of the first image and the second image is a detectable image point that is present in each of the first image and the second image and is detected in a ground plane surrounding the vehicle.

Example 3 is a method as in any of Examples 1-2, wherein computing coordinates for the ground feature of the first image and the second image comprises estimating three-dimensional coordinates utilizing an optical flow algorithm.

Example 4 is a method as in any of Examples 1-3, further comprising predicting a feature point location for the ground feature of the first image and the second image based on a prior computation retrieved from memory, wherein the feature point location is predicted before the optical flow algorithm is solved.

Example 5 is a method as in any of Examples 1-4, further comprising supplying the feature point location to the optical flow algorithm to improve accuracy in computing the three-dimensional coordinates for the ground feature of the first image and the second image.

Example 6 is a method as in any of Examples 1-5, further comprising: identifying an outlier point in one or more of the sequential images using a structure from motion algorithm; and rejecting the outlier point to improve the estimation of the speed and the yaw rate of the vehicle.

Example 7 is a method as in any of Examples 1-6, further comprising: computing a median flow from the first image to the second image indicating a movement of the monocular camera from a capture time of the first image to a capture time of the second image; wherein the median flow is calculated as a median of a change in coordinates for a plurality of image points of the first image compared with a plurality of corresponding image points of the second image.

Example 8 is a method as in any of Examples 1-7, further comprising: identifying outlier points comprising a first outlier point from the first image and a corresponding second outlier point from the second image; and rejecting the outlier points to reduce error in computing the median flow from the first image to the second image; wherein identifying the outlier points comprises detecting a change in coordinates from the first outlier point to the second outlier point that exceeds a predetermined threshold amount.

Example 9 is a method as in any of Examples 1-8, wherein estimating one or more of the speed and the yaw rate of the vehicle comprises utilizing rigid body transformation to measure a motion of the vehicle and an orientation change of the vehicle.

Example 10 is a method as in any of Examples 1-9, further comprising parameterizing rotation of the vehicle using Classical Rodriguez Parameter with Cayley Transform.

Example 11 is a method as in any of Examples 1-10, wherein the camera on the vehicle is a rear-view monocular camera attached to a rear of the vehicle.

Example 12 is a method as in any of Examples 1-11, further comprising extracting a region of interest from each of the sequential images, wherein a majority of the region of interest comprises a ground plane surrounding the vehicle and wherein the one or more ground features are detectable image points in the ground plane.

Example 13 is a method as in any of Examples 1-12, wherein the sequential images are received from the camera of the vehicle in real-time when the vehicle is traveling at a slow speed.

Example 14 is a system configured to estimate a speed and/or a yaw rate of a vehicle. The system includes a monocular camera configured to capture sequential images of a vehicle's surroundings. The system includes non-transitory computer readable storage media storing instruction that, when executed by one or more processors, cause the one or more processors to: receive sequential images comprising a first image and a second image from the monocular camera; extract one or more ground features from each of the sequential images; compute three-dimensional coordinates for a ground feature of the first image and the second image using an optical flow algorithm; and estimate one or more of a speed and a yaw rate of the vehicle based on a change in the three-dimensional coordinates for the ground feature from the first image to the second image.

Example 15 is a system as in Example 14, wherein the instructions further cause the one or more processors to: predict a feature point location for the ground feature of the first image and the second image based on a prior computation retrieved from memory, wherein the feature point location is predicted before the optical flow algorithm is solved; and incorporate the feature point location into the optical flow algorithm to improve accuracy in computing the three-dimensional coordinates for the ground feature of the first image and the second image.

Example 16 is a system as in any of Example 14-15, wherein the instructions further cause the one or more processors to: identify an outlier point in one or more of the sequential images using a structure from motion algorithm; and reject the outlier point to improve the estimation of the speed and the yaw rate of the vehicle.

Example 17 is a system as in any of Example 14-16, wherein the instructions further cause the one or more processors to: compute a median flow from the first image to the second image indicating a movement of the monocular camera from a capture time of the first image to a capture time of the second image; wherein the median flow is calculated as a median of a change in coordinates for a plurality of image points of the first image compared with a plurality of corresponding image points of the second image.

Example 18 is a system as in any of Example 14-17, wherein the instructions cause the one or more processors to estimate one or more of the speed and the yaw rate of the vehicle by utilizing rigid body transformation to measure a motion of the vehicle and an orientation change of the vehicle.

Example 19 is a system as in any of Example 14-18, wherein the instructions further cause the one or more processors to extract a region of interest from each of the sequential images, wherein a majority of the region of interest comprises a ground plane surrounding the vehicle and wherein the one or more ground features are detectable image points in the ground plane.

Example 20 is non-transitory computer readable storage media storing instructions that, when executed by one or more processors, cause the one or more processors to: receive sequential images comprising a first image and a second image from a monocular camera of a vehicle; extract one or more ground features from each of the sequential images; computer three-dimensional coordinates for a ground feature of the first image and the second image using an optical flow algorithm; and estimate one or more of a speed and a yaw rate of the vehicle based on a change in the three-dimensional coordinates for the ground feature from the first image to the second image.

Example 21 is a system or device that includes means for implementing a method or realizing a system or apparatus in any of Examples 1-20.

In the above disclosure, reference has been made to the accompanying drawings, which form a part hereof, and in which is shown by way of illustration specific implementations in which the disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Implementations of the systems, devices, and methods disclosed herein may comprise or utilize a special purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium, which can be used to store desired program code means in the form of computer-executable instructions or data structures and which can be accessed by a general purpose or special purpose computer.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links, which can be used to carry desired program code means in the form of computer-executable instructions or data structures and which can be accessed by a general purpose or special purpose computer. Combinations of the above should also be included within the scope of computer-readable media.

Computer-executable instructions comprise, for example, instructions and data which, when executed at a processor, cause a general-purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, an in-dash vehicle computer, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the description and claims to refer to particular system components. The terms “modules” and “components” are used in the names of certain components to reflect their implementation independence in software, hardware, circuitry, sensors, or the like. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a sensor may include computer code configured to be executed in one or more processors and may include hardware logic/electrical circuitry controlled by the computer code. These example devices are provided herein purposes of illustration and are not intended to be limiting. Embodiments of the present disclosure may be implemented in further types of devices, as would be known to persons skilled in the relevant art(s).

At least some embodiments of the disclosure have been directed to computer program products comprising such logic (e.g., in the form of software) stored on any computer useable medium. Such software, when executed in one or more data processing devices, causes a device to operate as described herein.

While various embodiments of the present disclosure have been described above, it should be understood they have been presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments but should be defined only in accordance with the following claims and their equivalents. The foregoing description has been presented for the purposes of illustration and description. It is not intended to be exhaustive or to limit the disclosure to the precise form disclosed. Many modifications and variations are possible in light of the above teaching. Further, it should be noted that any or all the aforementioned alternate implementations may be used in any combination desired to form additional hybrid implementations of the disclosure.

Further, although specific implementations of the disclosure have been described and illustrated, the disclosure is not to be limited to the specific forms or arrangements of parts so described and illustrated. The scope of the disclosure is to be defined by the claims appended hereto, any future claims submitted here and in different applications, and their equivalents.

What is claimed is:

1. A method comprising:
receiving sequential images comprising a first image and a second image from a camera of a vehicle;
extracting one or more ground features from each of the sequential images;
computing coordinates for a ground feature of the first image and the second image; and
estimating speed and yaw rate of the vehicle based on a change in the coordinates for the ground feature from the first image to the second image.

2. The method of claim 1, wherein the ground feature of the first image and the second image is a detectable image point that is present in each of the first image and the second image and is detected in a ground plane surrounding the vehicle.

3. The method of claim 1, wherein computing coordinates for the ground feature of the first image and the second image comprises estimating three-dimensional coordinates utilizing an optical flow algorithm.

4. The method of claim 3, further comprising predicting a feature point location for the ground feature of the first image and the second image based on a prior computation retrieved from memory, wherein the feature point location is predicted before the optical flow algorithm is solved.

5. The method of claim 4, further comprising supplying the feature point location to the optical flow algorithm to improve accuracy in computing the three-dimensional coordinates for the ground feature of the first image and the second image.

6. The method of claim 1, further comprising:
identifying an outlier point in one or more of the sequential images using a structure from motion algorithm; and
rejecting the outlier point to improve the estimation of the speed and the yaw rate of the vehicle.

7. The method of claim 1, further comprising:
computing a median flow from the first image to the second image indicating a movement of the monocular camera from a capture time of the first image to a capture time of the second image;
wherein the median flow is calculated as a median of a change in coordinates for a plurality of image points of the first image compared with a plurality of corresponding image points of the second image.

8. The method of claim 7, further comprising:
identifying outlier points comprising a first outlier point from the first image and a corresponding second outlier point from the second image; and
rejecting the outlier points to reduce error in computing the median flow from the first image to the second image;
wherein identifying the outlier points comprises detecting a change in coordinates from the first outlier point to the second outlier point that exceeds a predetermined threshold amount.

9. The method of claim 1, wherein estimating one or more of the speed and the yaw rate of the vehicle comprises utilizing rigid body transformation to measure a motion of the vehicle and an orientation change of the vehicle.

10. The method of claim 9, further comprising parameterizing rotation of the vehicle using Classical Rodriguez Parameter with Cayley Transform.

11. The method of claim 1, wherein the camera on the vehicle is a rear-view monocular camera attached to a rear of the vehicle.

12. The method of claim 1, further comprising extracting a region of interest from each of the sequential images, wherein a majority of the region of interest comprises a ground plane surrounding the vehicle and wherein the one or more ground features are detectable image points in the ground plane.

13. The method of claim 1, wherein the sequential images are received from the camera of the vehicle in real-time when the vehicle is traveling at a slow speed.

14. A system comprising:
a monocular camera configured to capture sequential images of a vehicle's surroundings; and
non-transitory computer readable storage media storing instruction that, when executed by one or more processors, cause the one or more processors to:
receive sequential images comprising a first image and a second image from the monocular camera;
extract one or more ground features from each of the sequential images;
compute three-dimensional coordinates for a ground feature of the first image and the second image using an optical flow algorithm; and
estimate one or more of a speed and a yaw rate of the vehicle based on a change in the three-dimensional coordinates for the ground feature from the first image to the second image.

15. The system of claim 14, wherein the instructions further cause the one or more processors to:
predict a feature point location for the ground feature of the first image and the second image based on a prior computation retrieved from memory, wherein the feature point location is predicted before the optical flow algorithm is solved; and
incorporate the feature point location into the optical flow algorithm to improve accuracy in computing the three-dimensional coordinates for the ground feature of the first image and the second image.

16. The system of claim 14, wherein the instructions further cause the one or more processors to:
identify an outlier point in one or more of the sequential images using a structure from motion algorithm; and
reject the outlier point to improve the estimation of the speed and the yaw rate of the vehicle.

17. The system of claim 14, wherein the instructions further cause the one or more processors to:
compute a median flow from the first image to the second image indicating a movement of the monocular camera from a capture time of the first image to a capture time of the second image;
wherein the median flow is calculated as a median of a change in coordinates for a plurality of image points of the first image compared with a plurality of corresponding image points of the second image.

18. The system of claim 14, wherein the instructions cause the one or more processors to estimate one or more of the speed and the yaw rate of the vehicle by utilizing rigid body transformation to measure a motion of the vehicle and an orientation change of the vehicle.

19. The system of claim 14, wherein the instructions further cause the one or more processors to extract a region of interest from each of the sequential images, wherein a majority of the region of interest comprises a ground plane surrounding the vehicle and wherein the one or more ground features are detectable image points in the ground plane.

20. Non-transitory computer readable storage media storing instructions that, when executed by one or more processors, cause the one or more processors to:
receive sequential images comprising a first image and a second image from a monocular camera of a vehicle;
extract one or more ground features from each of the sequential images;
computer three-dimensional coordinates for a ground feature of the first image and the second image using an optical flow algorithm; and
estimate one or more of a speed and a yaw rate of the vehicle based on a change in the three-dimensional coordinates for the ground feature from the first image to the second image.
